(19) United States
(12) Patent Application Publication
(10) Pub. No.: US 2015/0348178 A1
(43) Pub. Date: Dec. 3, 2015

(54) Method and System for Renting and Sub-Renting Vehicles

(71) Applicants: Verizon Patent and Licensing Inc., Arlington, VA (US); HTI IP, LLC, Arlington, VA (US); Cellco Partnership d/b/a Verizon Wireless, Arlington, VA (US)

(72) Inventors: Thomas S. Taylor, Atlanta, GA (US); Anik P. Jain, Laurel, MD (US); Howard Faber, Irving, TX (US); Victoria R. Lonker, Cary, NC (US); Justin M. Blair, Basking Ridge, NJ (US)

(73) Assignees: Verizon Patent and Licensing Inc., Arlington, VA (US); HTI IP, LLC, Arlington, VA (US); Cellco Partnership d/b/a Verizon Wireless, Arlington, VA (US)

(21) Appl. No.: 14/292,046

(22) Filed: May 30, 2014

(51) Int. Cl. G06Q 30/06

(52) U.S. Cl. CPC G06Q 30/0645

(57) ABSTRACT

A system and method for sub-renting a vehicle to a secondary/sub-renter after the vehicle has been rented to a primary renter. The vehicle may comprise a telematics control unit to enhance the sub-renting process. A rental duration of secondary renter(s) may be compared to an idle timeframe specified by the primary renter. Other rental parameters may be compared to enhance sub-renting of the vehicle, such as an idle location and a vehicle class of the vehicle, for example. In this manner, rented vehicles can be utilized more, particularly during periods when the primary renter has no need to use the rented vehicle. Secondary renters are enabled to use/rent the vehicle during these idle periods and the primary renter can avoid paying for more than he or she needs.

### FIELD OF THE INVENTION

The field of the present invention relates generally to a method and system for sub-renting vehicles during idle times.

### BACKGROUND

One of the problems with the rental car industry is that the rented vehicles are often underutilized. The vehicles are often rented so that the renter can go from one location to another, without much, if any, usage in between. For example, a renter may rent a vehicle at the airport (point A) for the purpose of getting to a convention center (point B). Upon arriving at the convention center, the renter parks the rented vehicle and attends the convention. At the conclusion of the convention, the renter takes the vehicle from the convention center back to the airport. In such situations, the vehicle sits idle for several days while the renter has no need to use the rented vehicle. The vehicle is underutilized and the renter is paying for more than he or she needs.

Additionally, conventional carsharing programs involve a driver using a single car owned by the carsharing company for a period of time in a limited jurisdiction. Renters in such carsharing programs do not have the ability to sub-rent the vehicle they are currently renting, and are limited to using the same vehicle for the duration of their rental period. Moreover, conventional carsharing programs do not exploit the capabilities of telematics control modules onboard vehicles.

### BRIEF DESCRIPTION OF THE DRAWINGS

In order to facilitate a fuller understanding of the exemplary embodiments, reference is now made to the appended drawings, in which like reference characters are used to indicate like elements. These drawings should not be construed as limiting, but are intended to be exemplary only.

FIG. 1 depicts a block diagram of a system architecture for gathering data, renting, and sub-renting vehicles, according to an exemplary embodiment;

FIG. 2 depicts a block diagram of a hardware module for gathering data, sending data, accessing vehicles, determining charges, and renting/sub-renting vehicles, according to an exemplary embodiment of the invention;

FIG. 3 depicts exemplary sources of data to aid in renting and sub-renting vehicles, according to an exemplary embodiment of the invention;

FIG. 4 depicts exemplary comparisons of input parameters for the purpose of renting and/or sub-renting vehicles, according to an exemplary embodiment of the invention;

FIG. 5 depicts an illustrative flowchart of a method for renting and sub-renting vehicles, according to an exemplary embodiment.

### DETAILED DESCRIPTION OF EMBODIMENTS

A system is needed that manages vehicles which are available for re-renting, regardless of the entity that owns the vehicle or the geographic location of the vehicle. The detailed description below provides exemplary embodiments of methods and systems that enable novel re-renting capabilities. Reference will now be made in detail to exemplary embodiments, examples of which are illustrated in the accompanying drawings. It should be appreciated that the same reference numbers will be used throughout the drawings to refer to the same or like parts. The following description is intended to convey a thorough understanding of the embodiments described by providing a number of specific embodiments. It should be appreciated that the following detailed descriptions are exemplary and explanatory only and are not restrictive. As used herein, any term in the singular may be interpreted to be in the plural, and alternatively, any term in the plural may be interpreted to be in the singular.

The description below describes modules that may include one or more servers, databases, subsystems and other components. As used herein, the term “module” may be understood to refer to non-transitory executable software, firmware, a processor or other hardware, and/or various combinations thereof. Modules, however, are not to be interpreted as software that is not implemented on hardware, firmware, or recorded on a tangible processor-readable or recordable storage medium (i.e., modules are not software per se). The modules are exemplary and may be combined, integrated, separated, and/or duplicated to support various applications and may be centralized or distributed. A function described herein as being performed at a particular module may be performed at one or more other modules and/or by one or more other devices instead of or in addition to the function performed at the particular module. The modules may be implemented across multiple devices and/or other components local or remote to one another. Though not necessarily depicted, the modules may comprise one or more databases. The devices and components that comprise one module may or may not be distinct from the devices and components that comprise other modules.

Embodiments of the system provide the ability to gather data from a user or driver, a device associated with user(s) or driver(s), vehicle(s), databases, and/or third party sources, for the exemplary purpose of sub-renting rented vehicles. As used herein, the term “sub-renting” or “re-renting” may be interpreted as renting a vehicle that has already been rented to a driver who does not own the vehicle. A vehicle may be rented by a “primary” renter for a period of time. That vehicle may be re-rented (or sub-rented), with the approval of the primary renter, to a “secondary renter” or “sub-renter” for at least a portion of the period of time that the primary renter is renting the vehicle. The primary renter may rent a vehicle for a period of time (i.e., the primary rental duration), and not use the vehicle for portions of that period of time (i.e., the idle timeframe). The primary renter and/or the vehicle itself may notify the system of when and where the vehicle is or will be sitting idle (i.e., not in use by the primary renter), and the system may then allow secondary renters to rent the vehicle for a secondary rental duration. The primary renter may be entitled to a vehicle during the primary rental period outside of the specified idle timeframe, but not necessarily the same vehicle. As explained in exemplary embodiments, the primary renter may use one vehicle during a portion of the primary rental period, and use another vehicle during another portion of the primary rental period, particularly in situations where the first vehicle was sub-rented to a secondary renter and the first vehicle is still being used by the secondary renter (or another renter) when the primary renter needs to use a rented vehicle again during the primary rental period (e.g., upon expiration of the idle timeframe). Accordingly, the primary renter may use different vehicles before and after the vehicle idle timeframe if another vehicle is available.

Various exemplary embodiments relate to gathering data from a telematics control unit (“TCU module”) on the vehicle, from the user/renter him/herself, from a device of the user/renter (such as a mobile device), from various databases, and/or from various third parties to aid in renting and sub-renting of vehicles. In exemplary embodiments, vehicle data, drive data, location data, user/renter data, and/or time data may be used to determine whether to make a vehicle available for sub-renting and how the rental transaction with the primary renter will be adjusted. An exemplary way in which the rental transaction with the primary renter would be adjusted is by adjusting the price of the rental transaction. If a vehicle is successfully sub-rented during a primary rental period, the price charged to the primary renter may be lower than situations where the vehicle was not successfully sub-rented. Whether a vehicle is “successfully” sub-rented may depend on several factors, including the primary renter's use of the vehicle, reception of data from the primary renter regarding vehicle idle times (i.e., idle times of the “primary” vehicle), the presence of secondary renters, the secondary renter's use of the vehicle, and the availability of other (“secondary”) vehicles in situations where the secondary renter will not be able to return the primary vehicle back to the primary renter's location before the idle period ends, for example.

In an exemplary embodiment, a primary renter may rent a primary vehicle having a TCU module at location “A” (e.g., an airport), and then drive the primary vehicle to location “B” (e.g., a hotel). The primary renter may be attending a three-day conference that runs Thursday morning through Saturday afternoon. The primary renter may rent the vehicle Wednesday evening at location “A” (e.g., the airport), and then park the vehicle at location “B” (e.g., the hotel) that same evening, with no intention of using the vehicle again until Saturday afternoon. Rather than pay for a multi-day (e.g., 72 hour) rental period, the primary renter may wish to make the vehicle available for sub-renting from Thursday morning to Saturday morning, i.e., during the expected period when the primary renter does not plan on using the vehicle. The primary renter may inform the sub-renting system of the expected “idle times” or “idle period” of the primary vehicle (e.g., Thursday morning to Saturday morning). Thereafter, the sub-renting system may advertise the primary vehicle as being available for (sub-) rental, and identify the current location (location “B”) of the primary vehicle (e.g., the hotel). The sub-renting system may or may not specify that the primary vehicle needs to be returned to its current location (location “B”) by Saturday morning, depending on the availability of other vehicles that the primary renter can use in the event that the primary vehicle is not returned before the idle period ends. The sub-renting system may adjust the price of the sub-rental as a result of any extra conditions that are placed on a potential secondary renter (e.g., a condition that the vehicle needs to be returned to a particular location by a particular time). In the event a secondary renter does sub-rent the primary vehicle, the sub-renting system may inform the primary renter that the primary vehicle has been sub-rented, whether the primary vehicle will be returned to location “B” (e.g., the hotel) before the end of the specified idle period (e.g., Saturday morning), whether other vehicles are available for rental use in the event the primary vehicle is not returned in time by the secondary renter, and/or an expected amount that the primary renter is saving by sub-renting the primary vehicle. For example, upon renting the primary vehicle to a secondary renter, the sub-renting system may send a message to the primary renter stating, “The convertible you rented at Sky Harbor Airport on Wednesday evening has been sub-rented and will be returned to your location prior to Saturday morning at 11:00 AM with the keys inside. You are expected to save $145 off of the original rental price of $215 as a result of allowing the convertible to be sub-rented during the times you specified. In the event the convertible is not returned to your location by 11:00 AM Saturday morning, another rental vehicle of similar vehicle class will be made available for you at your location.” Messages from the sub-renting system may be in the form of an email, text message, voice message, or pop-up notification, for example. The sub-renting system may also be configured to inform the primary renter of the location of the primary rented vehicle (or a substitute vehicle) after the vehicle is no longer being used by a secondary renter. For example, a secondary renter may return the vehicle to location “A,” but the vehicle may not be parked at the same location where the primary renter parked the vehicle. In such an event, the sub-renting system may retrieve location data from the vehicle's TCU module and relay the vehicle's location to the primary renter after the vehicle has been returned to location “A” by the secondary renter. Communications between the sub-renting system, the primary renter, and/or any secondary renters, may occur via an application on a mobile device, via a website on the Internet, or via a display in the vehicle, for example. The sub-renting system may monitor vehicle usage, vehicle status, location data, user data, driver data, and/or time data for the purpose of renting or sub-renting vehicles, communicating with renters, and/or adjusting a renter's service contract, for example. Additional details of exemplary embodiments are disclosed below with reference to the figures.

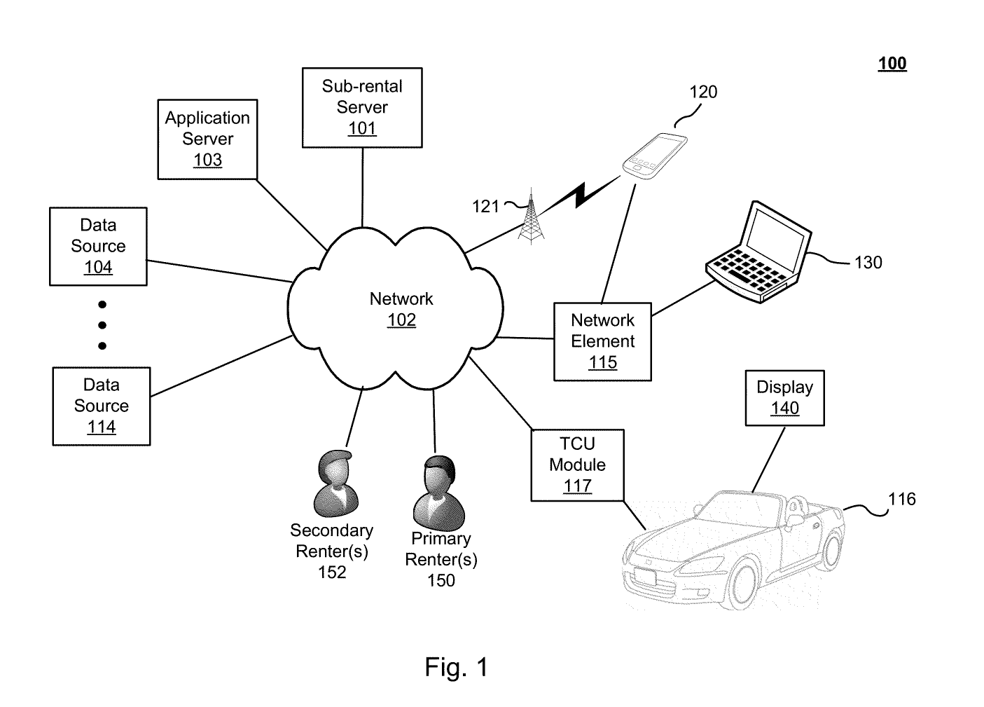

Referring to FIG. 1, a schematic diagram of a system 100 for gathering data from various sources or devices is shown, according to an exemplary embodiment. As illustrated, sub-rental server 101 may be communicatively coupled with one or more TCU modules 117, one or more data transmitting devices or entities, network element 115, wireless transceiver 121, application server 103, mobile device 120, vehicle display 140, or network client 130, for example. These and other types of devices may be communicatively coupled directly with network 102 or via one or more intermediary devices, such as transceiver 121 or network element 115. Sub-rental server 101 may also function to offer and arrange rentals in addition to sub-rentals, but to emphasize the sub-rental capability, the server has been termed a sub-rental server 101.

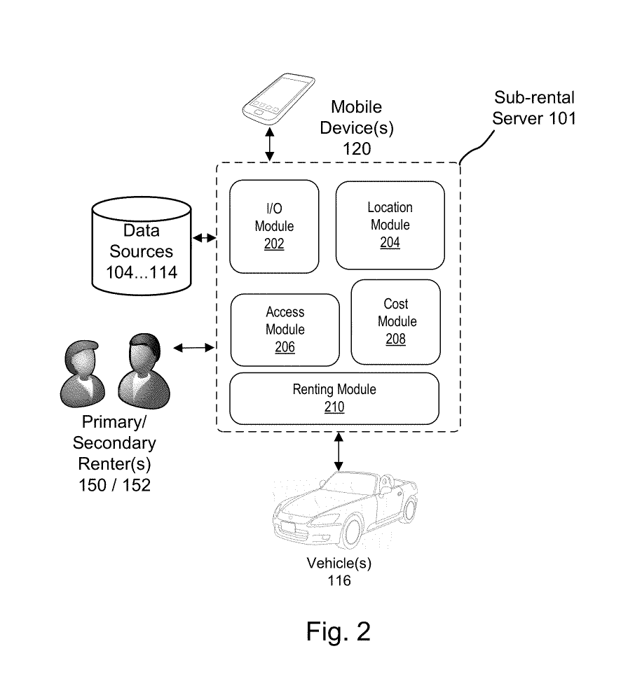

It should be appreciated that the system 100 of FIG. 1 may be implemented in a variety of ways. Architecture within system 100 may be implemented as a hardware component (e.g., as a module) within a network element or network box. It should also be appreciated that architecture within system 100 may be implemented in computer executable software (e.g., on a tangible computer-readable medium). Module functionality of architecture within system 100, and even the sub-rental server 101 of FIG. 2, may be located on a single device or distributed across a plurality of devices including one or more centralized servers and one or more mobile units or end user devices.

Network 102 may be a wireless network, a wired network or any combination of wireless network and wired network. For example, network 102 may include one or more of a fiber optics network, a passive optical network, a cable network, an Internet network, a satellite network (e.g., operating in Band C, Band Ku or Band Ka), a wireless LAN, a Global System for Mobile Communication (“GSM”), a Personal Communication Service (“PCS”), a Personal Area Network (“PAN”), D-AMPS, Wi-Fi, Fixed Wireless Data, IEEE 802.11a, 802.11b, 802.15.1, 802.11g, 802.11n, 802.11ac, or any other wired or wireless network for transmitting or receiving a data signal. In addition, network 102 may include, without limitation, telephone line, fiber optics, IEEE Ethernet 802.3, a wide area network (“WAN”), a local area network (“LAN”), or a global network such as the Internet. Also, network 102 may support, an Internet network, a wireless communication network, a cellular network, Bluetooth, or the like, or any combination thereof. Network 102 may further include one, or any number of the exemplary types of networks mentioned above operating as a stand-alone network or in cooperation with each other. Network 102 may utilize one or more protocols of one or more network elements to which it is communicatively coupled. Network 102 may translate to or from one protocol to one or more other protocols of network devices. Although network 102 is depicted as one network, it should be appreciated that according to one or more embodiments, network 102 may comprise a plurality of interconnected networks, such as, for example, a service provider network, the Internet, a broadcaster's network, a cellular network, corporate networks, municipal networks, government networks, or home networks.

Network client 130 may be a desktop computer, a laptop computer, a tablet, a server, a personal digital assistant, or other computer capable of sending or receiving network signals. Network client 130 may use a wired or wireless connection. It should also be appreciated that the network client 130 may be a portable electronic device capable of being transported. Primary or secondary renters may use network client 130 to communicate with sub-rental server 101.

Transceiver 121 may be a repeater, a microwave antenna, a cellular tower, or another network access device capable of providing connectivity between different network mediums. Transceiver 121 may be capable of sending or receiving signals via a mobile network, a paging network, a cellular network, a satellite network or a radio network. Transceiver 121 may provide connectivity to one or more wired networks and may be capable of receiving signals on one medium such as a wired network and transmitting the received signals on a second medium, such as a wireless network.

Mobile device 120 may be a mobile communications device, a smartphone, a tablet computer, a wearable computer such as in the form of a watch, bracelet, or glasses, a home phone, a cellular phone, a mobile phone, a satellite phone, a personal digital assistant, a computer, a handheld multimedia device, a personal media player, a gaming device, a mobile television, or other devices capable of displaying messages and communicating directly with network 102 or via transceiver 121. Mobile device 120, network client 130, and TCU module 117 may connect to network 102 and communicate with other network elements, servers or providers using WiFi, 3G, 4G, Bluetooth, or other chipsets. Primary or secondary renters may use mobile device 120 to communicate with sub-rental server 101.

TCU module 117 on vehicle 116 may provide substantially all of the data relating to the vehicle and its location, motion, or acceleration. The TCU module 117 may collect large amounts of data regarding the vehicle 116 to which it is attached, including: location (GPS, GLONASS), engine status, speed, stops, starts, temperature, amount of gas in fuel tank, miles per gallon (mpg), acceleration values, nearby Wi-Fi signals (for example, through detection of a short-range wireless signal such as Bluetooth or Wi-Fi, or over a wireless network such as LTE), gyroscope sensor information, height information from an altimeter, visual information from a camera communicatively coupled to the TCU module 117, audio from a microphone, or revolutions per minute (RPM) of the vehicle's engine, for example. Data may be gathered from multiple TCU modules on multiple vehicles, and it should be appreciated that “TCU module” may refer to “one or more TCU modules.” Such data may be gathered anonymously. The TCU module 117 may include a number of sensors including an accelerometer, barometer, altimeter, and gyroscope, for example. The TCU module 117 may include a number of communication chipsets, including WiFi, 3G, 4G, Bluetooth, and also may include one or more processors.

Exemplary data that may be captured by the TCU module 117 over a period of time include location (e.g., latitude and longitude coordinates), fuel levels, miles per gallon, heading (e.g., degrees), weather conditions (e.g., degrees, precipitation), whether the window wipers are on/off, vehicle speed, vehicle status (e.g., on/off, an indication of whether maintenance is required and what type, engine status, engine temperature, oil life or percentage remaining, or tire pressure), whether the headlights are on/off, application of brakes, wheel slippage, skidding, sliding, rate of acceleration (measured in g's in the x, y, z directions, for example), pressure values (e.g., kPa), altitude, grade (rate of incline/decline), forces at wheels, damping forces, fuel consumption, etc. All or a subset of this data may be used by the sub-rental server 101 to rent or sub-rent vehicles, communicate with renters, designate vehicles as available to rent or not available to rent, and/or adjust a renter's service contract, for example.

Location data may be collected every 1-2 seconds while the vehicle is running, for example, by a GPS module within the TCU module 117. When the vehicle is shut off, the last collected location data may be used as the vehicle's “parked” location, until the vehicle is turned on again and location data continues to be collected. The vehicle's parked location may be transmitted by the TCU module 117 to sub-rental server 101. Acceleration data may be collected by an accelerometer at 50 Hz, for example, and pressure data may be collected by a barometer at 10 Hz, for example. All of the collected data may have a timestamp and location-stamp associated with it to indicate when and where the data was collected, and this timestamp and location-stamp may be tagged to the data itself, and eventually stored in one or more modules of sub-rental server 101 or in the renter database 107. Data may be collected continuously over a period of time until the vehicle is turned off or until the user directly or indirectly deactivates the TCU module 117.

With further reference to FIG. 1, network element 115 may include one or more processors (not shown) to transmit and receive data to and from network 102. The data may be transmitted and received utilizing a standard telecommunications protocol or a standard networking protocol. For example, one embodiment may utilize text messages and/or a Short Message Service “SMS.” In other embodiments, the data may be transmitted or received utilizing Session Initiation Protocol (“SIP”), Voice Over IP (“VoIP”), or other messaging protocols. Data may also be transmitted or received using Wireless Application Protocol (“WAP”), Multimedia Messaging Service (“MMS”), Enhanced Messaging Service (“EMS”), Global System for Mobile Communications (“GSM”) based systems, Code Division Multiple Access (“CDMA”) based systems, Transmission Control Protocol/Internet Protocols (“TCP/IP”), hypertext transfer protocol (“HTTP”), hypertext transfer protocol secure (“HTTPS”), real time streaming protocol (“RTSP”), or other protocols and systems suitable for transmitting and receiving data. Data may be transmitted and received wirelessly or in some cases may utilize cabled network or telecom connections such as an Ethernet RJ45/Category 5 Ethernet connection, a fiber connection, a cable connection or other wired network connection. A number of different types of signals or notifications may be transmitted via network 102 including, but not limited to, text messages, a voice message (including computer generated voice messages), an email, a prompt, a banner, a pop-up, a video signal, a link, or any combination of the foregoing.

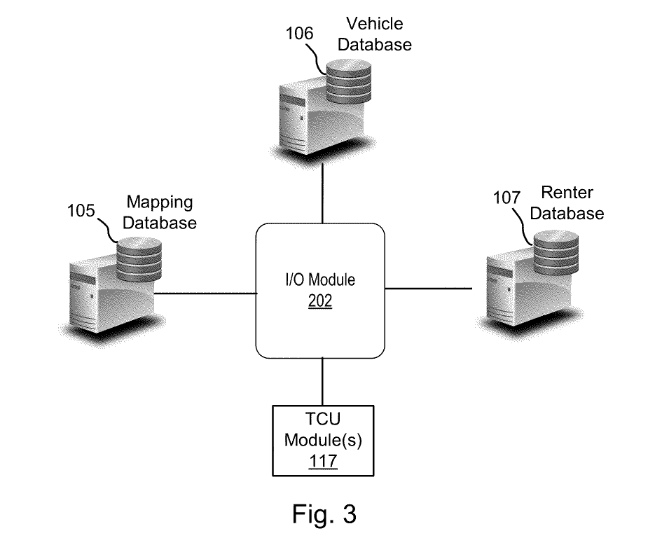

Data sources 104 . . . 114 represent various databases or entities that provide relevant data, such as mapping data, location data, geographic data, calendar data, user data, renter data, application data, contact information, vehicle data, pricing data, or other forms of data. For simplicity, as shown in FIG. 3, the various sources of data may be considered to be stored in mapping database 105, vehicle database 106, and/or renter database 107. Data from TCU module 117 may also be retrieved by I/O module 202, as reflected in FIG. 3.

Application server 103 may provide an application to a computing device such as mobile device 120, vehicle display 140, or network client 130, for example. Via an application installed on the computing device, renter 150 may communicate with sub-rental server 101, enter or modify input parameters, specify vehicle idle times, specify a desire to sub-rent a rented vehicle, and establish various user settings, for example. The application may be linked to or comprise a third-party application, such as a maps application. In one exemplary embodiment, the application may be the Verizon Navigator application.

Primary renter 150 may be a primary renter of vehicle 116. Secondary renter 152 may be a secondary or sub-renter of vehicle 116, or a potential (sub-) renter. While FIG. 1 only shows primary renter(s) 150 and secondary renter(s) 152 for clarity, other sub-renters (for example, tertiary renters or additional secondary renters) may also be involved. Primary and secondary renter(s) 150/152 may communicate with sub-rental server 101 via network 102 using mobile device 120, network client 130, or vehicle display 140, for example.

Vehicle display 140 may include a display in vehicle 116, such as a touchscreen device or a dashboard display, including a plasma display panel (PDP), liquid crystal display (LCD), thin film transistor (TFTLCD), super LCD, light emitting diode (LED), organic LED (OLED), active matrix OLED (AMOLED), LED-backlit LCD, super AMOLED, a retina display, or a heads-up-display (HUD).

As referred to above, FIG. 3 shows exemplary sources of data that may be used by embodiments of the present invention (and which may generally correspond to data sources 104 . . . 114 in FIG. 1).

Mapping database 105 may include maps data, location data, geographic data, building data, traffic data, or GPS data, for example. Sources of this data may be a third party that provides such data for free or for a fee, and may include Google Maps®, OpenStreetMap, NavTeq®, Garmin®, Apple®, Microsoft®, Yahoo®, or TrafficMetrix, for example.

Vehicle database 106 may include information about vehicles that are currently being rented/sub-rented or vehicles that are available for rent/sub-rent. Information about the vehicles may include the vehicle's year, make, model, color, features, location, owner, renter, sub-renter, status, availability, mileage, damage, accident history, repair history, maintenance history, VIN number, license plate number, TCU module port/address. Entities or individuals who wish to enter their vehicles into the rental inventory can do so by providing information about their vehicles to the sub-rental server 101. Once in the rental inventory, the vehicles may be available for rental and/or sub-rental. This represents one exemplary advantage of the disclosed system over conventional carsharing systems—the system disclosed herein is not limited to a particular car rental company or a small group of individuals. Rather, several car rental companies may opt to participate in the sub-rental system 100 in order to utilize their individual cars more, and to decrease costs to their customers by allowing their customers to sub-rent the rented vehicles. Currently, there is not a system to manage any rental car, regardless of the company that owns the vehicle. The system disclosed herein, however, allows rental car companies to “share” customers by allowing their customers to sub-rent the rented vehicles. Such “customer sharing” goes beyond the concept of traditional carsharing. Traditional carsharing does not involve sub-renting rented vehicles. Moreover, in one exemplary embodiment, a renter may use one vehicle owned by a first car rental company, sub-rent that vehicle to a sub-renter, and then use another vehicle owned by another car rental company.

Data in the vehicle database 106 may be indexed according to any one or more of the exemplary data types listed above. Vehicle features may pertain to features that are available on the vehicle, including engine type, size, transmission, or rated mpg; safety features, such as anti-lock brakes, airbags, collision ratings; audio features, such as type of radio (AM/FM/XM/CD/HD); communication features, such as Bluetooth connectivity, touchscreen, head up display (HUD), smart-car capability, GPS; interior features, such as passenger seats or cargo space, for example. Vehicle location data may pertain to the vehicle's current, former, or anticipated location. The vehicle's current or former location may be gathered from the vehicle's TCU module 117. The vehicle's anticipated location may be based on input from renter 150. For example, a sub-renter 150 may specify that he/she will return vehicle 116 to location “A” by time “T.” Accordingly, vehicle database may record the anticipated location of vehicle 116 as location “A” as of time “T.” Nevertheless, TCU module 117 may continue to send location data to sub-rental server 101, which may store such data in vehicle database 106. Sub-rental server 101 may continually compare a vehicle's current location to a vehicle's anticipated location to determine whether it is likely that the vehicle will make it to the anticipated location at the specified time. Sub-rental server 101 may also take into account traffic data retrieved from mapping database 105, for example. In the event that a determination is made that vehicle 116 will not make it to the anticipated location in time (based on current time, current location, distance away from the anticipated location, and/or traffic information), then sub-rental server 101 may send a message to the primary renter 150 and/or the secondary renter 152 informing them of the situation.

Renter database 107 may include data input by, or gathered over time about, primary renter(s) 150 and/or secondary renter(s) 152 (collectively renters), data provided by or about renters, renter preferences, contact information, renter relationships, renter accounts (e.g., user accounts and financial accounts), renter login information, and/or a quantitative and qualitative assessment of such data. Sources of renter data 108 may include the renter personally, a device associated with the renter, the vehicle 116 (TCU module 117) driven by the renter, or a third party, for example.

Data from the TCU module 117 may be input into vehicle database 106 and/or renter database 107. Exemplary data from TCU module 117 that may be input into vehicle database 106 includes, but is not limited to, mileage (e.g., miles recorded over time or total mileage), location (e.g., GPS coordinates), fuel levels (e.g., amount of gas consumed or remaining), engine status (e.g., on/off, an indication of whether and what type of maintenance is required, engine temperature, oil life or percentage remaining), or tire pressure, for example. All or a subset of this data may be used by the sub-rental server 101 in determining whether a vehicle can be rented or sub-rented. Exemplary data from TCU module 117 that may be input into renter database 107 includes, but is not limited to, mileage traveled by renter, location of vehicle, fuel levels, engine status, tire pressure, vehicle speed, vehicle status, application of brakes, wheel slippage, skidding, sliding, rate of acceleration (including deceleration), heading (including rate of change in heading), and g-forces, for example. All or a subset of this data may be used by the sub-rental server 101 in determining whether a vehicle can be rented or sub-rented and may also influence the price charged to a renter or sub-renter of the vehicle. For example, primary renter 150 may drive vehicle 116 non-aggressively (as measured, for example, by comparing rates of acceleration, deceleration, and heading change to average values of such rates for other drivers or to threshold values). Primary renter 150 may also fill up the vehicle with fuel when the fuel level is low. A secondary renter 152, on the other hand, who sub-rents vehicle 116 from primary renter 150, may drive vehicle 116 aggressively (as measured, for example, by comparing rates of acceleration, deceleration, and heading change to average values of such rates for other drivers or to threshold values), and may return the vehicle to the primary renter's location with a low fuel level (e.g., less than ¼ tank of gas). The secondary renter 152 may be penalized for such aggressive driving and/or for returning the vehicle with low fuel level, in the form of an increased sub-rental price. Accordingly, cost module 208 of sub-rental server 101 may take into account various data from TCU module 117, vehicle database 106, and/or renter database 107 when determining a price to charge primary or secondary renters 150/152.

FIG. 2 shows a block diagram of hardware modules at a sub-rental server 101, configured to perform various functions including, but not limited to, gathering data, determining vehicle status, determining whether vehicles are or can be rented/sub-rented, outputting messages, and determining cost associated with renting/sub-renting vehicles, according to an exemplary embodiment of the invention. Data may be gathered by or received at I/O module 202 and stored therein or in other modules of sub-rental server 101. I/O module 202 of sub-rental server 101 may retrieve data from mapping database 105, vehicle database 106, renter database 107, TCU module 117, primary renter(s) 150, secondary renter(s) 152, or other data sources such as third party entities, for example. Data from renter(s) 150/152 may include, for example, data input by the renter(s), including various parameters, renter settings, or a timeframe or calendar associated with, or input by, the renter, for example. Data from the various sources may have timestamps and location-stamps associated therewith to aid in determining whether to rent and/or sub-rent vehicles. The modules may communicate data with each other and sub-rental server 101 may communicate with other system architecture components shown in FIG. 1. To carry out their functions, the modules may have executable instructions stored in a program memory within one or more of the modules. One or more processors coupled to or within the modules are configured to carry out the executable instructions to allow the module to carry out its functions. Using executable instructions and a processor, sub-rental server 101 is able to determine whether a vehicle 116 can or should be rented or sub-rented.

I/O module 202 may receive data over time from renter 150/152, vehicle 116 (including TCU module 117), mobile device 120, or other data sources. In an exemplary embodiment, the data may include drive data, location data, time data, and/or renter input data. Drive data may comprise sensor data from TCU module 117 on vehicle 116, examples of which are enumerated above. Location data may comprise the location of vehicle(s) 116 (or TCU module(s) 117), renter 150/152, the location of a renter's mobile device 120, rental location, drop-off location, or another specified location, for example. Time data may be associated with both the drive data and the location data such that the system knows when the particular data was recorded. Time data may also include rental duration, idle timeframe, vehicle usage timeframe, or calculations related thereto. Renter input data may comprise information or input parameters retrieved from renter 150/152, including timeframes of when a primary renter 150 does and/or does not plan on using/renting vehicle 116, timeframes of when a secondary renter 152 would like to use/sub-rent vehicle 116, and/or renter information including name, address, telephone number, cell phone number, driver's license ID, credit card information, insurance information, rental location, and/or rental drop-off location, for example.

By way of further explanation, various exemplary embodiments are provided below. In one exemplary embodiment, driver A (e.g., primary renter 150) wishes to rent vehicle A (e.g., vehicle 116) for duration A, such as four days. Driver A provides renter input data (e.g., input parameters) to I/O module 202 of sub-rental server 101 using, for example, an application on driver A's smartphone (which application may be provided by application server 103) or a website on the Internet. Input parameters of driver A may include the desired rental duration (e.g., four days), timeframes when driver A does and/or does not plan on using vehicle A during the rental duration (i.e., the “idle timeframe” or a timeframe from which the idle timeframe may be calculated by sub-rental server 101) (e.g., driver A may not plan on using vehicle A on days two and three of the four-day rental duration), and driver A's name, address, telephone number, cell phone number, driver's license ID, credit card information, and/or insurance information, for example. Driver A may also specify a desired rental location (e.g., an airport), a desired drop-off location (e.g., the same airport or another location), and/or a desired vehicle class/type for renting (e.g., hybrid, convertible, mid-size, full-size, luxury, SUV, van, minivan, truck). Sub-rental server 101 may store this exemplary renter input data in renter database 107 and vehicle database 105 under a record for driver A and vehicle A, respectively. At the desired rental location or another location, an individual associated with sub-rental server 101 may confirm the information received from driver A by, for example, viewing or making a record of driver A's driver's license and/or credit card, for example. Upon receipt (and/or validation) of renter input data from driver A, sub-rental server 101 may authorize driver A to rent vehicle A. Sub-rental server 101 may send data to driver A indicative of the location of vehicle A, such as on a map and/or a homing signal, for example. Other information may also be sent to driver A, including the license plate number, car make, model, and year, and/or car color, for example. Like other information communicated from sub-rental server 101, the vehicle location data or other information may be sent to a mobile device, to an application on a mobile device (such as a rental application or a map application), or in a message, such as a text message, email message, or pop-up notification, for example. Using the received vehicle location data, driver A may locate vehicle A. Upon locating vehicle A, driver A may send a request to sub-rental server 101 to unlock vehicle A. Sub-rental server 101 may confirm that driver A is located approximate to (near) vehicle A. This may be accomplished by asking driver A to verify the last four digits of vehicle A's vehicle identification number (VIN), the car registration month expiration (as shown on the license plate), or other information that may only be known by looking at the vehicle, for example. Sub-rental server 101 may then send a signal to TCU module 117 on vehicle A to have TCU module 117 unlock vehicle A. Driver A may then enter vehicle A, locate the keys to vehicle A (e.g., in the glove compartment), and then drive vehicle A from the rental location to a desired location (such as a hotel parking lot near a convention center where driver A will be attending a three-day convention). Driver A may then leave the keys to vehicle A in vehicle A (such as in the glove compartment). Driver A may then lock vehicle A and depart on foot. Alternatively, using a mobile device, driver A may send a signal to sub-rental server 101 causing sub-rental server 101 to send a signal to TCU device 117 to lock vehicle A. Alternatively, a signal may be sent from the driver directly to TCU device 117 to unlock/lock the vehicle. The location where the vehicle will be idle during the idle timeframe may be considered the “idle location.”

Sub-rental server 101 may have previously processed the renter input data of driver A, particularly the idle timeframe(s) when driver A is not planning on using vehicle A (e.g., days two and three of the four-day rental duration), and may have updated vehicle database 106 with respect to a data record for vehicle A, to indicate that vehicle A will be available for sub-rental on “day 2” and/or “day 3” of driver A's rental duration. Accordingly, sub-rental server 101 may have offered vehicle A for sub-rent on days two and three, to users of the sub-rental system 101, before or during the idle timeframe(s). For example, this information may be posted on a website or made available within an application on users' mobile devices, and other users may be permitted to reserve the vehicle for sub-rent in advance of, or during, the idle timeframe.

Sub-rental server 101 may receive a reservation request from driver B, who wishes to sub-rent a vehicle for a duration that falls within the idle timeframe of driver A's rental duration and near the idle location of vehicle A (e.g., the hotel parking lot where driver A drove vehicle A). The reservation request from driver B may include renter input data of driver B (e.g., input parameters), such as the desired sub-rental duration (e.g., one day), driver B's name, address, telephone number, cell phone number, driver's license ID, credit card information, and/or insurance information, for example, and, optionally, timeframes when driver B does and/or does not plan on using the sub-rented vehicle during the sub-rental duration (i.e., “secondary idle timeframes”). Such secondary idle timeframes from driver B may not be requested or inputted if the desired (sub-)rental duration for driver B is short (e.g., a few hours). Driver B may also specify a desired rental location, a desired drop-off location (e.g., which may be the same as the desired rental location), and/or a desired vehicle class for renting. Driver B may look specifically for vehicles available for sub-rent (perhaps because such vehicles have a discounted (sub-)rental price), or driver B may not care whether a vehicle is rented or sub-rented to him/her, but may simply specify when he/she would like to use/(sub-)rent a vehicle. If driver B specifically requests vehicle A for sub-renting, driver B may be informed of the conditions of the (sub-)rental. For example, sub-rental server 101 may inform driver B of time constraints associated with vehicle A, such as when vehicle A needs to be returned to its current location. If driver B simply specifies when he/she would like to (sub-)rent a vehicle, (without specifying a desire to sub-rent, for example) driver B may be presented with vehicle A, the fact that vehicle A is a sub-rental, conditions/time constraints associated with vehicle A, and the corresponding cost, which cost may be lower as a result of the extra conditions attached to sub-renting vehicle A. If driver B chooses to sub-rent vehicle A, similar to above, sub-rental server 101 may inform/remind driver B of the time constraints associated with vehicle A, such as when vehicle A needs to be returned to its current location.

Assuming driver B desires and agrees to sub-rent vehicle A, the sub-rental process will continue. Upon receipt (and/or validation) of renter input data from driver B, sub-rental server 101 may authorize driver B to sub-rent/use vehicle A. Sub-rental server 101 may store the renter input data received from driver B in renter database 107 and vehicle database 106 under a record for driver B and vehicle A, respectively. Sub-rental server 101 may also update the record for driver A in renter database 107 to reflect that vehicle A has been sub-rented and any corresponding information, such as expected drop-off time by driver B. Sub-rental server 101 may send, via I/O module 202 and network 102, a message to driver A indicating that vehicle A has been sub-rented. The message may also indicate how much driver A is saving (e.g., in $ or %) by allowing vehicle A to be sub-rented, and may also indicate when vehicle A is expected to be back at the idle location (i.e., driver B's drop-off location).

Referring back to driver B, sub-rental server 101 may send information to driver B indicative of the location of vehicle A, such as on a map and/or a homing signal, for example. Other information may also be sent to driver B, including the license plate number, car make, model, and year, and/or car color, for example. As above, information may be sent to a mobile device, to an application on a mobile device (such as a rental application or a map application), or in a message, such as a text message, email message, or pop-up notification, for example. Using the received vehicle location data, driver B may locate vehicle A. Upon locating vehicle A, driver B may send a request to sub-rental server 101 (or directly to TCU module 117) to unlock vehicle A. Sub-rental server 101 may confirm that driver B is located approximate to (near) vehicle A. This may be accomplished by asking driver B to verify the last four digits of vehicle A's vehicle identification number (VIN), the car registration month expiration (as shown on the license plate), or other information that may only be known by looking at the vehicle, for example. Sub-rental server 101 may then send a signal to TCU module 117 on vehicle A to have TCU module 117 unlock vehicle A. Driver B may then enter vehicle A, locate the keys to vehicle A (e.g., in the glove compartment, where driver A left them), and then drive vehicle A from the idle location to a desired location (such as a shopping center or the beach, for example). Driver B would not need to leave the keys in the vehicle during this time unless driver B wanted to possibly further sub-rent vehicle A to another sub-renter (e.g., a tertiary renter).

To enhance security, TCU module 117 may be configured to only allow the vehicle to operate upon receiving a “go-ahead” signal from sub-rental server 101, regardless of whether the vehicle's keys are in the ignition. Accordingly, even if someone knows that the vehicle's keys are in the vehicle (e.g., in the glove compartment), the vehicle may not operate unless TCU module 117 permits such operation, which permission may be granted by sub-rental server 101, for example.

Additionally, TCU module 117 may be further configured to store in memory various driver settings. For example, TCU module 117 may retain in memory settings associated with driver A and driver B in the present example. Thus, when driver A obtains possession of vehicle A again, TCU module 117 may restore driver A's electrical or electromechanical settings, such as driver's seat location, steering wheel location, suspension height, mirror settings, radio settings, and/or A/C or heat settings, for example.

Assuming driver B does not further sub-rent vehicle A, at the end of driver B's rental duration, driver B may drop off vehicle A back at the idle location where driver B originally picked up vehicle A. At such location, vehicle A may now be available for another sub-renter, such as driver C. Alternatively, vehicle A may be used by driver A if driver A logs into his/her account and changes the idle timeframe such that driver A is now permitted to drive vehicle A again. Driver A may only be permitted to change the originally specified idle timeframe if no other driver has reserved vehicle A for sub-rental during the originally-specified idle timeframe(s).

In another exemplary embodiment, driver B's drop-off location may not be driver A's idle location, or driver B's (sub-)rental duration may extend passed driver A's idle timeframe. Sub-rental server 101 may allow such instances to occur if another vehicle (of similar or better vehicle class, for example) is available for driver A to use at driver A's idle location after driver A's idle timeframe has ended. In other words, driver A may use a different vehicle than vehicle A to drive back to the original rental location (e.g., the airport) if another vehicle is available; and driver B may not be limited by the time constraints associated with driver A's idle timeframe and idle location. Nevertheless, prices may be adjusted accordingly if driver B, despite the original input parameters provided by driver B, wishes to use vehicle A beyond driver A's idle timeframe or if driver B does not wish to drop off vehicle A at driver A's idle location at the end of driver B's (sub-)rental duration. Alternatively, driver B may be surcharged if driver B agreed to drop off vehicle A at driver A's idle location at the end of driver B's (sub-)rental duration, but failed to do so. Such a surcharge may be a fixed cost or may represent the cost to deliver another rental vehicle to driver A's idle location or the cost of a taxi for driver A to use, for example.

Assuming that driver B returned vehicle A back to the idle location at the end of driver B's agreed-upon rental duration (e.g., the end of day two of driver A's four-day rental duration), vehicle A may be available for sub-rental yet again. Sub-rental server 101 may have previously processed the renter input data of driver B, particularly the rental duration specified by driver B (e.g., days two of driver A's four-day rental duration), and may have updated vehicle database 106 with respect to a data record for vehicle A, to indicate that vehicle A will be available for sub-rental on “day 3” of driver A's rental duration. Accordingly, sub-rental server 101 may have offered vehicle A for sub-rent on day three, to users of the sub-rental system 101. As above, this information may be posted on a website or made available within an application on users' mobile devices.

Sub-rental server 101 may receive a reservation request from driver C, who wishes to sub-rent a vehicle for a duration that falls within the remaining idle timeframe of driver A's rental duration (e.g., day three) and near the idle location of vehicle A (i.e., the drop-off location of driver B, which was the hotel parking lot where driver A originally drove vehicle A). The reservation request from driver C may include renter input data of driver C (e.g., input parameters), such as the desired sub-rental duration (e.g., one day), driver C's name, address, telephone number, cell phone number, driver's license ID, credit card information, and/or insurance information, for example, and, optionally, timeframes when driver C does and/or does not plan on using vehicle A during the sub-rental duration (i.e., yet another “secondary idle timeframe”). Such secondary idle timeframes from driver C may not be requested or inputted if the desired (sub-)rental duration for driver C is short (e.g., a few hours). Before choosing a particular vehicle, driver C may also specify a desired rental location, a desired drop-off location (which drop-off location may be the same as the desired rental location), and/or a desired vehicle class for renting. If driver C's desired rental location and desired drop-off location correspond to the idle location (exactly or approximately), and driver C's desired vehicle class corresponds (exactly or approximately) to the vehicle class of vehicle A, driver C may be presented vehicle A for sub-renting. Similar to driver B, driver C may look specifically for vehicles available for sub-rent (perhaps because such vehicles have a discounted (sub-)rental price), or driver C may not care whether a vehicle is rented or sub-rented to him/her, but may simply specify when he/she would like to use/(sub-)rent a vehicle. If driver C specifically requests vehicle A for sub-renting, driver C may be informed of the conditions of the (sub-)rental. For example, sub-rental server 101 may inform driver C of time constraints associated with vehicle A, such as when vehicle A needs to be returned to its current location (e.g., by the end of day three). If driver C simply specifies when he/she would like to (sub-)rent a vehicle, (without specifying a desire to sub-rent, for example) and the parameters input by driver C match up with vehicle A's relevant parameters (e.g., driver C's rental duration, rental location/drop-off location, and vehicle class compared to driver A's remaining idle timeframe, idle location, and vehicle class, respectively), then driver C may be presented with vehicle A, an indication that vehicle A is a sub-rental, conditions/time constraints associated with vehicle A, and the corresponding cost, which cost may be lower as a result of the extra conditions attached to sub-renting vehicle A. If driver C chooses to sub-rent vehicle A, similar to above, sub-rental server 101 may inform/remind driver C of the time constraints associated with vehicle A, such as when vehicle A needs to be returned to driver A's idle location.

Assuming driver C desires and agrees to sub-rent vehicle A, the sub-rental process will continue. Upon receipt (and/or validation) of renter input data from driver C, sub-rental server 101 may authorize driver C to sub-rent vehicle A. Sub-rental server 101 may store the renter input data received from driver C in renter database 107 and vehicle database 105 under a data record for driver C and vehicle A, respectively. Sub-rental server 101 may also update the record for driver A in renter database 107 to reflect that vehicle A has again been sub-rented and any corresponding information, such as expected drop-off time by driver C. Sub-rental server 101 may also send, via I/O module 202 and network 102, a message to driver A indicating that vehicle A has again been sub-rented. The message may also indicate how much driver A is saving (e.g., in $ or %) by allowing vehicle A to be sub-rented again, and may also indicate when vehicle A is expected to be back at the idle location (i.e., driver C's drop-off location).

Referring back to driver C, sub-rental server 101 may send information to driver C indicative of the location of vehicle A, such as on a map and/or a homing signal, for example. Other information may also be sent to driver C, including the license plate number, car make, model, and year, and/or car color, for example. As above, information may be sent to a mobile device, to an application on a mobile device (such as a rental application or a map application), or in a message, such as a text message, email message, or pop-up notification, for example. Using the received vehicle location data, driver C may locate vehicle A. Upon locating vehicle A, driver C may send a request to sub-rental server 101 to unlock vehicle A. Alternatively, driver C may communicate with TCU module 117 via a mobile device to cause TCU module 117 to unlock vehicle A. Sub-rental server 101 may confirm that driver C is located approximate to (near) vehicle A. This may be accomplished by asking driver C to verify the last four digits of vehicle A's vehicle identification number (VIN), the car registration month expiration (as shown on a sticker on the license plate, for example) or other information that may only be known by being near the vehicle, for example. Access module 206 of sub-rental server 101 may then send a signal to TCU module 117 on vehicle A to have TCU module 117 unlock vehicle A. Driver C may then enter vehicle A, locate the keys to vehicle A (e.g., in the glove compartment, where driver B left them), and then drive vehicle A from the idle location to a desired location (such as a restaurant or sports complex, for example). Driver C would not need to leave the keys in the vehicle during driver C's rental duration unless driver C wanted to possibly further sub-rent vehicle A to another sub-renter (e.g., another potential tertiary renter).

Assuming driver C does not further sub-rent vehicle A, at the end of driver C's rental duration (e.g., near the end of day three), driver C may drop off vehicle A back at the idle location where driver C originally picked up vehicle A. At such location, vehicle A may now be available for driver A, and driver A's idle timeframe may be nearing an end. Accordingly, after the end of driver A's idle timeframe, on day four of driver A's rental duration, sub-rental server 101 may send information to driver A indicative of the location of vehicle A, such as on a map and/or a homing signal, for example. Driver A may need to know the location of vehicle A because driver C may have parked vehicle A in a different location from where driver A originally parked vehicle A at the idle location. Other information may also be sent to driver A to remind driver A about details of vehicle A, including the license plate number, car make, model, and year, and/or car color, for example. As above, information may be sent to a mobile device, to an application on a mobile device (such as a rental application or a map application), or in a message, such as a text message, email message, or pop-up notification, for example. Using the received vehicle location data, driver A may locate vehicle A. Upon locating vehicle A, driver A may communicate with TCU module 117 or send a request to sub-rental server 101 to unlock vehicle A (e.g., via an application in driver A's mobile device or via a webpage). Sub-rental server 101 may then send a signal to TCU module 117 on vehicle A to have TCU module 117 unlock vehicle A. Driver A may then enter vehicle A, locate the keys to vehicle A (e.g., in the glove compartment, where driver C left them), and then drive vehicle A to the drop-off location originally specified by driver A (e.g., the airport).

For the sake of simplicity, fuel levels of vehicle A have not been elaborated upon in the above examples. Nevertheless, TCU module 117 may monitor fuel levels in vehicle 116 (e.g., vehicle A) and may calculate how much fuel each driver (e.g., drivers A, B, and C) consumed. Accordingly, the primary and any secondary renters/sub-renters may be charged accordingly for fuel consumed. A (sub-)rental condition may also be imposed on the primary and secondary renters. For example, the renters may be required to leave the vehicle with at least ½ tank of gas upon parking the vehicle at the drop-off location at the end of their respective (sub-)rental duration. TCU module 117 may also record how much fuel is purchased/inserted by each renter, and may adjust each rental charge accordingly. In such manner, the renters need not be concerned with filling the car exactly to ½ tank to satisfy the exemplary ½ tank minimum requirement, so as to not spend money on extra (not required) fuel. As mentioned above, in the event one driver violates the exemplary ½ tank fuel requirement, such driver may be surcharged accordingly, and the relevant surcharge (and/or cost deduction) may be calculated or determined by cost module 208. If a subsequent driver needs to fill the vehicle up with fuel in order to use the vehicle and/or drive the vehicle back to the drop-off location, then the amount expended (in $) to fill the vehicle up with fuel may be deducted from that driver's rental charge. For example, if driver C in the above example returned vehicle A with ¼ tank of fuel, and driver A needed more fuel than ¼ tank to use the vehicle and/or drive the vehicle back to the driver A's drop-off location, and driver A filled vehicle A with fuel to make up for driver C's deficiency, then driver C may be surcharged by a fixed amount or the amount expended by driver A to fill up the car with fuel. Similarly, driver A's rental charge may be reduced by the amount expended to fill the vehicle up with fuel. By using data gathered by the TCU module 117 on-board vehicle 116, sub-rental server 101 may ensure that no driver is unfairly charged for fuel that he/she did not consume.

Cost module 208 may also be configured to charge renters/sub-renters based on how many miles are driven. Conventionally, drivers are charged based on a rental duration, which may not be desired for drivers who do not plan on using the vehicle throughout their rental duration. By charging drivers for actual miles driven by the driver, the actual utilization cost of the vehicle may be more closely approximated. The TCU module 117 may measure how many miles are driven over a period of time. This data, combined with specified rental use periods (i.e., times outside of the idle timeframe(s) but within the rental duration period), allows sub-rental server 101 to know which drivers actually drove the vehicle at particular times.

Moreover, as mentioned above, TCU module 117 may also be used to determine whether any of the primary/secondary renters 150/152 aggressively used vehicle 116. A rental condition may specify that the renters not drive the rented vehicle 116 overly aggressively, and various examples may be provided in a contract between the renters and the car rental company. Additionally or alternatively, the renters may be sent a message by sub-rental server 101 indicating whether various driving data has been classified as “aggressive.” Rental conditions in the contract between the renters and the car company may specify a “three strikes, you're out” rule, for example, where three “strikes” for aggressive driving will result in a surcharge of some pre-defined amount. Of course, the number of “strikes” may be more or less than three, but such number would preferably be specified in the contract. Moreover, messages indicating an “aggressive” driving classification may be sent to the renter's smartphone or directly to vehicle display 140, for example, so the driver will immediately be informed/reminded of the potential consequences of his/her aggressive driving. Data from TCU module 117 may be analyzed by renting module 210 on a real-time or near real-time basis to categorize and/or weigh driving data. Various driving data may be categorized, such as a hard stop or a hard turn, for example. Either the GPS data or accelerometer data gathered by the TCU module may be used to determine whether the vehicle stopped or turned. However, classifying a stop, for example, as a “hard” stop may be done by comparing the accelerometer data (or rate of change of location data) to a threshold value. For example, a stop where the vehicle's velocity decreases by more than 20 ft/sec, on average, may be classified as a “hard stop” or a “sudden stop.” Alternatively, a “hard stop” may be categorized as a stop involving deceleration greater than 0.5 g, for example, where “g” is a measure of g-force. If the driver slows to a stop by a rate slower than 20 ft/sec (or at a rate lower than 0.5 g), then the stop may be categorized as a “soft stop” or not categorized at all. Similarly, turns may be categorized as either “hard turns” or “soft turns” or not classified at all. A gyroscope may be most effective in classifying turns, but a combination of data may be used. The rate of change of a vehicle's heading may be used to categorize whether turns are “hard” or “soft.” Additionally, gyroscope data may be combined with velocity data or accelerometer data in categorizing various events. A rapid change in a vehicle's heading may not be considered a “hard turn” if the vehicle's velocity is very low. However, as the vehicle's velocity increases, a smaller rate of change in the vehicle's heading may still be considered a “hard turn.” Accordingly, a plurality of values may be used to categorize turns as either “hard” or “soft.” Alternatively, accelerometer data alone may be sufficient to categorize particular driving data as either “hard” or “soft.” For example, centrifugal forces or other g-forces measured by the accelerometer in the TCU module 117 may be compared to a predetermined threshold value. A turn that produces a centrifugal force in excess of 1.5 g, for example, may be considered a “hard” turn, where “g” is a measure of g-force. Additional “aggressive” driving may include speeding and/or driving speedily over speed bumps, for example. Driving in excess of 85 mph, for example, may be classified as speeding; and driving greater than 35 mpg when driving over a speed bump (as detected by force measurements at the wheels and interpreted by TCU module 117) may also be classified as speeding. Upon any of these classifications, sub-rental server 101 may send a message to the driver/renter informing them of such classification and the potential/actual surcharge to be applied.

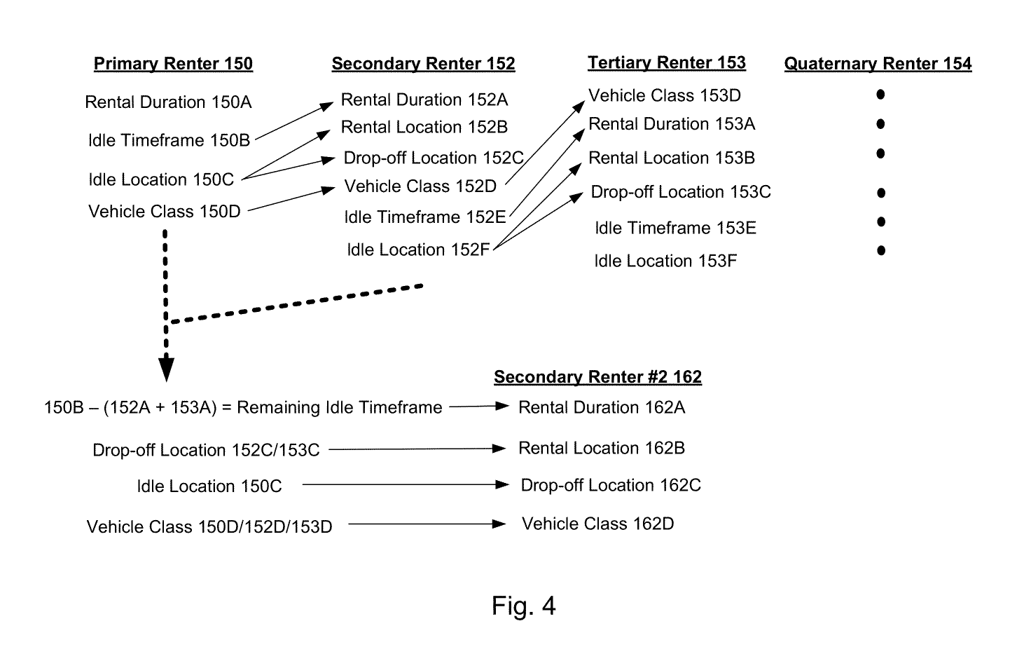

FIG. 4 shows some exemplary input parameters organized according to renter. Comparisons of this data may be performed by sub-rental server 101 when determining whether to sub-rent a vehicle. Solid arrows in FIG. 4 represent such comparison of parameters. Each of the items/parameters in FIG. 4 may be input by a renter, determined by TCU module 117, and/or calculated by sub-rental server 101. Moreover, the parameters in FIG. 4 may be stored in the renter database 107 and/or the vehicle database 106, with respect to the relevant renter/sub-renter and/or vehicle, respectively. For example, primary renter 150 may specify, upon making a rental reservation, a rental duration 150A, i.e., the desired duration that primary renter 150 desires to rent the vehicle; an idle timeframe 150B, i.e., one or more periods of time during which primary renter 150 will not be using the vehicle; idle location 150C, i.e., the location where the vehicle will be parked at the beginning of (or during) the idle timeframe 150B; and the vehicle class 150D, i.e., the desired vehicle class or type that primary renter 150 desires to use/rent. Alternatively, TCU module 117, itself, may specify idle location 150C, for example. Primary renter 150 may also specify a rental location (i.e., the location from which primary renter will pick-up the vehicle at the beginning of the rental duration 150A) and a drop-off location (i.e., the location at which the primary renter will drop off the vehicle at the end of the rental duration 150A), though this information is not necessarily compared to other renter data/input parameters for the purpose of sub-renting by sub-rental server 101.

Each of 150A, 150B, 150C, and 150D may be input by the primary renter 150 while making a rental reservation. Sub-rental server 101 may use the data precisely as input by primary renter 150 or modify the data. For example, primary renter 150 may specify that the vehicle will not be used from 9 AM to 5 PM on a particular day, thereby suggesting that the vehicle can be sub-rented during this time. Sub-rental server 101 may interpret this data as an eight hour idle timeframe 150B for primary renter 150. Additionally or alternatively, sub-rental server 101 may modify this idle timeframe 150B by applying a buffer time (e.g., 1 hour) to yield an effective idle timeframe. The purpose of a buffer time may be to account for late arrivals or early departures of the primary renter 150 and/or a sub-renter. For example, if the primary renter originally planned to not use the vehicle starting at 9 AM, but was late parking the vehicle at the idle location 150C, then a sub-renter who reserved the vehicle for 9 AM would be unfairly impacted by the primary renter's delinquency. The same may be said of the primary renter 150 if a sub-renter, who reserved the vehicle until 5 PM, was late parking the vehicle back at the idle location 150C. Accordingly, application of a buffer time to the idle timeframe 150B, or other timeframes (e.g., rental duration), input by a renter/sub-renter may help avoid such problems.

Referring again to FIG. 4, secondary renter 152, tertiary renter 153, quaternary renter 154, and secondary renter #2 162 may all be considered “sub-renters.” Other sub-renters may also be involved. Tertiary renter 153 may also be considered a sub-renter with respect to secondary renter 152, and quaternary renter 154 may also be considered a sub-renter with respect to tertiary renter 153. Secondary renter #2 162 may be considered a second sub-renter with respect to primary renter 150. Each of the renters/sub-renters may use the same vehicle, but at different times. Additional renters/sub-renters and vehicles may be involved, but for the sake of clarity, reference will only be made to primary renter 150, secondary renter 152, tertiary renter 153, secondary renter #2 162, and one vehicle.

Secondary renter 152 may specify similar information to that specified by the primary renter 150, while making a rental reservation. For example, secondary renter 152 may specify a rental duration 152A, a rental location 152B, a drop-off location 152C, a vehicle class 152D, and may optionally specify an idle timeframe 152E and an idle location 152F if secondary renter 152 is interested in potentially sub-renting the vehicle. Upon receipt of this information from secondary renter 152, renting module 210 of sub-rental server 101 may compare the idle timeframe 150B of primary renter 150 to the rental duration 152A of secondary renter 152. Moreover, renting module 210 may compare idle location 150C to rental location 152B and/or drop-off location 152C; and vehicle class 150D may be compared to vehicle class 152D. If the various parameters line up correctly, as determined by renting module 210 of sub-rental server 101, then the vehicle rented by primary renter 150 may be sub-rented to secondary renter 152. For example, if rental duration 152A falls within (i.e., is of equal or shorter duration than) idle timeframe 150B, then a comparison of these two values by renting module 210 may return a “pass” result. For example, assume primary renter 150 entered an idle timeframe of Thursday morning thru Friday night, and secondary renter enters a rental duration of 8 hours on Thursday. A comparison of these values will return a “pass” result, and the vehicle rented by primary renter 150 may be presented to secondary renter 152 as a possible sub-rental. This “presentation” of vehicles is assumed to be in conjunction with the secondary renter making a rental reservation, which may occur on a website or in an application on a computing device used by the secondary renter, for example. Moreover, the “presentation” may occur on a map or in a list of locations, such that the vehicle's location and proximity may be readily determined.

Continuing the present example, if idle location 150C matches rental location 152B (and in some embodiments, drop-off location 152C), then a comparison of these values by renting module 210 may also return a “pass” result. Idle location 150C may be said to match rental location 152B and/or drop-off location 152C if they are sufficiently near each other geographically (e.g., in the same zip code or within 1 mile, for example). Secondary renter 152 may be flexible as to the exact rental location 152B and drop-off location 152C. Accordingly, upon entry of a desired rental location 152B and drop-off location 152C, various vehicle options may be presented to secondary renter 152, such as vehicles within a default or chosen geographical distance/area with respect to the desired rental location 152B and/or drop-off location 152C. For example, assume secondary renter enters address “B” as his/her desired rental location 152B and drop-off location 152C, and requests possible rental vehicles within 1 mile of address “B.” If the rental vehicle at idle location 150C is within 1 mile of address “B,” then the vehicle may be presented to secondary renter 152 as a possible sub-rental.

Further, renting module 210 may compare vehicle class 150D to vehicle class 152D. Again, vehicle class may refer to the type of vehicle (e.g., hybrid, convertible, mid-size, full-size, luxury, SUV, van, minivan, truck). If vehicle class 152D matches, or is similar to, vehicle class 150D, then the vehicle rented by primary renter 150 may be presented to secondary renter 152 as a possible sub-rental. As can be seen, various parameters of data input by the secondary renter 152 may be compared to parameters input by primary renter 150. If a sufficient number of parameters line up, then the vehicle rented by primary renter 150 may be presented to secondary renter 152 as a possible sub-rental.

In the event that secondary renter 152 also wishes to sub-rent (i.e., sub-sub-rent) the vehicle to another sub-renter (e.g., tertiary renter 153), secondary renter 152 may specify an idle timeframe 152E and an idle location 152F. Sub-rental server 101 may prevent secondary renter 152 from offering the vehicle as another sub-rental if the idle timeframe 152 is too short in duration (e.g., two hours) or if the remaining idle timeframe 150B of the primary renter 150 is too short in duration. The remaining idle timeframe may be calculated by subtracting the rental duration 152 of secondary renter 152 (and possibly the rental duration of a tertiary renter and quaternary renter 154, etc.) from the idle timeframe 150B of primary renter 150. Such a calculation is shown under the dashed arrow in FIG. 4. Assuming that the idle timeframe 152E and the remaining idle timeframe are not too short in duration, the vehicle may be sub-rented to tertiary renter 153. Before the vehicle is sub-rented to tertiary renter 153, similar comparisons may be made between the parameters entered by tertiary renter 153 and secondary renter 152, as explained above with respect to secondary renter 152 and primary renter 150. If tertiary renter 153 does end up sub-renting the vehicle, then secondary renter 152 will still likely have possession of the vehicle again before dropping the vehicle off at drop-off location 152C/idle location 150C. It may be that secondary renter 152 does not use the vehicle after expiration of idle timeframe 152E and before expiration of rental duration 152A. In such a case, the last person to use the vehicle may have been tertiary renter 153. Sub-rental server 101 may track which renters/sub-renters use the vehicle, and when, so as to enable or improve the renting/sub-renting process. For example, by tracking which renters/sub-renters use the vehicle, when such use occurs, and/or the extent of such use, sub-rental server 101 may appropriately charge the renters/sub-renters by the mile or by the hour/minute, levy surcharges (e.g., late fees or fuel fees), or assist when problems arise. For example, if primary renter 150 discovers an item left in the vehicle by a sub-renter, then sub-rental server 101 may be able to determine whose item was left based on when the item was discovered and when the different sub-renters used the vehicle.

Continuing the above example, assume rental duration 152A of secondary renter 152 has come to an end, and secondary renter 152 has dropped off the vehicle at the drop-off location 152C, which may correspond to idle location 150C. If the remaining idle timeframe (calculated as shown in FIG. 4) is of sufficient duration, then the vehicle may be sub-rented again, such as to secondary renter #2 162. If rental duration 162A falls within (i.e., is of equal or shorter duration than) the remaining idle timeframe, then a comparison of these two values by the renting module 210 may return a “pass” result. Also, drop-off location 152C and 153C may be the same as idle location 150C, but this is not mandatory. For example, assume secondary renter 152 parks the vehicle at drop-off location 152C, which is different than idle location 150C. This is acceptable if the rental location 162B of secondary renter #2 162 is the same as (or approximate to) drop-off location 152C, and drop-off location 162C is the same as (or approximate to) idle location 150C. In other words, even if secondary renter 152 drops off the vehicle at a different location than where secondary renter 152 originally retrieved the vehicle, that would be acceptable if secondary renter #2 162 retrieves the vehicle from where secondary renter 152 parked the vehicle, and secondary renter #2 162 later parks the vehicle at the idle location 150C of the original primary renter 150. In short, if respective comparisons between (i) the remaining idle timeframe, drop-off location 152C/153C, idle location 150C, vehicle class 150D, and (ii) rental duration 162A, rental location 162B, drop-off location 162C, and vehicle class 162D, all result in a “pass” result (i.e., the respective sub-renter parameters fall within, match, or approximately match the renter parameters), then the vehicle may be presented to secondary renter #2 162 as a possible sub-rental vehicle.

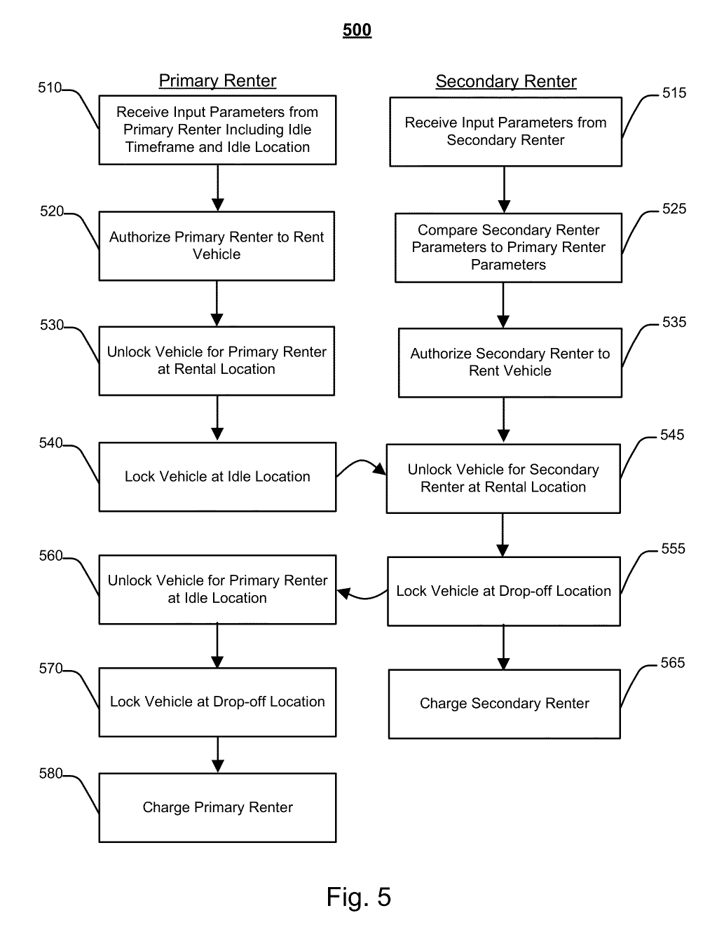

Referring to FIG. 5, an illustrative flowchart of a method for renting and sub-renting a vehicle is shown. This exemplary method 500 is provided by way of example, as there are a variety of ways to carry out methods according to the present disclosure. The method 500 shown in FIG. 5 can be executed or otherwise performed by one or a combination of various systems and modules. The method 500 described below may be carried out by system 100 shown in FIG. 1 and sub-rental server 101 shown in FIG. 2, by way of example, and various elements of the system 100 and sub-rental server 101 are referenced in explaining the exemplary method of FIG. 5. Each block shown in FIG. 5 represents one or more processes, decisions, methods or subroutines carried out in exemplary method 500, and these processes, decisions, methods or subroutines are not necessarily carried out in the specific order outlined in FIG. 5, nor are each of them required. Referring to FIG. 5, exemplary method 500 may begin at block 510.

At 510, sub-rental server 101 may receive input parameters from primary renter 150. Importantly, an idle timeframe is received from primary renter 150 as an input parameter. An idle location may be input by primary renter 150 or output by TCU module 117. Sub-rental server 101 may provide a portal on the Internet or an application on a computer or mobile device, through which primary renter 150 and secondary renter 152 may input parameters as part of the rental initiation process. The input parameters may be received via I/O module 202.

At 520, sub-rental server 101 may authorize primary renter 150 to rent/use vehicle 116. As part of this authorization, sub-rental server 101 may validate information received from the primary renter 150 and may update renter database 107 and vehicle database 106 to include information about the primary renter 150 and the vehicle to be rented by primary renter 150. Authorization may also comprise performing a credit check on the renter by submitting information to, and receiving information from, one or more credit agencies. The authorization may be performed by renting module 210, and I/O module 202 may receive and output messages as part of the authorization process. For example, upon authorization, I/O module 202 may send a message to primary renter 150 with details of the vehicle 116 to be rented, including vehicle location, as well as any other pertinent information to the rental/sub-rental process. Pertinent information may include how to locate vehicle 116, how to unlock vehicle 116, where the keys are located, any agreed-upon idle location and idle timeframe, information on how to change the input parameters, including the idle location and idle timeframe, and conditions related thereto.

At 530, primary renter 150 may physically locate vehicle 116 at the rental location and access module 206 may unlock vehicle 116 for the primary renter 150. Exemplary methods for unlocking vehicle 116 and assuring that primary renter 150 is physically proximate to vehicle 116 are described above. Upon accessing and starting vehicle 116, the driving data may be recorded by TCU module 117 and transmitted to sub-rental server 101. Driving data may include the real-time and historical location of vehicle 116, driving behavior, vehicle settings, fuel levels, mileage driven, and associated timestamps for such data. Sub-rental server 101 may use the driving data to assist primary renter 150 or secondary renter 152, to enable sub-rental of vehicle 116 to secondary renter 152, and/or to monitor various charges that should be added to or deducted from an amount charged to primary renter 150, for example.

At 540, primary renter 150 may arrive at and park the vehicle 116 at the designated idle location, and leave the keys in vehicle 116. Sub-rental server 101 may send a message to primary renter 150 or to vehicle 116 (such as to display 140) to remind primary renter 150 to leave the keys inside vehicle 116. Alternatively, TCU module 117 may cause such a message to appear on vehicle display 140 upon a driver shutting off the vehicle or shifting to park. Either primary renter 150, TCU module 117, or access module 206 may lock vehicle 116. Primary renter 150 may cause access module 206 to lock vehicle 116 by sending a data message to sub-rental server 101 using an application on a mobile device 120 or via an Internet website, for example.

Meanwhile, a secondary renter 152 may have already set up a sub-rental or may have yet to do so. At 515, sub-rental server 101 may receive input parameters from secondary renter 152. Similar to above, sub-rental server 101 may provide a portal on the Internet or an application on a computer or mobile device, through which secondary renter 152 may input parameters as part of the (sub-)rental initiation process. The input parameters may be received at sub-rental server 101 via I/O module 202.

At 525, renting module 210 may compare the input parameters of secondary renter 152 to the input parameters of primary renter 150 (which may be stored in renter database 107) by renting module 210. As explained above with reference to FIG. 4, the idle timeframe 150B, idle location 150C, and vehicle class 150D may be compared to the rental duration 152A, rental location 152B/drop-off location 152C, and vehicle class 152D, respectively, as indicated by the arrows in FIG. 4. In the present embodiment, if (1) the rental duration 152A is shorter than or equal to the idle timeframe 150B, (2) the rental location 152B and/or drop-off location 152C (depending on whether there is another secondary renter, as explained above) is the same as or approximate to (near) idle location 150C, and (optionally) (3) the vehicle class 152D is the same as or similar to vehicle class 150D, then vehicle 116 may be presented to secondary renter 152 as a possible sub-rental.

If secondary renter 152 decides to proceed with using vehicle 116 as a sub-rental, then at 535, sub-rental server 101 may authorize secondary renter 152 to sub-rent vehicle 116. As part of this authorization, sub-rental server 101 may validate information received from the secondary renter 152, update renter database 107 and vehicle database 106 to include information about the secondary renter 152 and the vehicle 116 to be rented by secondary renter 152, and receive confirmation from secondary renter 152 as to the conditions associated with sub-renting vehicle 116. For example, sub-rental server 101 may require secondary renter 152 to agree to have vehicle 116 back at idle location 150C at the end of the secondary renter's rental duration 152, and may also require secondary renter 152 to agree to any surcharges for failing to abide by this condition or other conditions (such as fuel level conditions). The authorization may be performed by renting module 210, and I/O module 202 may receive and output messages as part of the authorization process. For example, upon authorization, I/O module 202 may send a message to secondary renter 152 with details of the vehicle 116 to be sub-rented, including vehicle location (e.g., idle location 150C), as well as any other pertinent information to the sub-rental process. Pertinent information may include how to locate vehicle 116, how to unlock vehicle 116, where the keys are located, any agreed-upon rental duration, rental location, drop-off location, vehicle class, idle location, idle timeframe, information on how to change the input parameters, including drop-off location, and any idle location or idle timeframe, for example.

At 545, secondary renter 152 may physically locate vehicle 116 at idle location 150C and access module 206 may unlock vehicle 116 for the secondary renter 152. Exemplary methods for unlocking vehicle 116 and assuring that secondary renter 152 is physically proximate to vehicle 116 are described above. Upon accessing and starting vehicle 116, the driving data may be recorded by TCU module 117 and transmitted to sub-rental server 101. Similar to above, driving data may include the real-time and historical location of vehicle 116, driving behavior, vehicle settings, fuel levels, mileage driven, and associated timestamps for such data. Sub-rental server 101 may use the driving data to assist primary renter 150 or secondary renter 152, to enable sub-rental of vehicle 116 to another secondary (or tertiary) renter, and/or to monitor various charges that should be added to or deducted from an amount charged to secondary renter 150, for example.

At 555, the rental duration 152A may come to an end and secondary renter 152 may arrive at and park vehicle 116 at the drop-off location 152C, which may be the same as the designated idle location 150C, and secondary renter 152 may leave the keys in vehicle 116. Sub-rental server 101 may send a message to secondary renter 152 or to vehicle 116 (such as to display 140) to remind secondary renter 152 to leave the keys inside vehicle 116. Either secondary renter 152, TCU module 117, or access module 206 may lock vehicle 116. Secondary renter 152 may cause access module 206 to lock vehicle 116 by sending a data message to sub-rental server 101 using an application on a mobile device 120 or via an Internet website, for example. Upon or after arrival at drop-off location 152C, sub-rental server 101 may send a message to primary renter 150 indicating that vehicle 116 is back at the idle location 150C. Additionally or alternatively, primary renter 150 may be informed that another sub-renter (e.g., tertiary renter 153 or secondary renter #2 162) will be sub-renting vehicle 116. If another sub-renter will be renting vehicle, similar processes will occur with respect to the additional sub-renter and the remaining idle timeframe.

At 565, secondary renter 152 may be charged for the sub-rental by cost module 208. Cost module 208 may take into account miles driven, fuel consumed, length of rental duration 152A, length of any idle timeframes 152B, vehicle class 152D, rental location 152B, drop-off location 152C, driving data associated with secondary renter 152 (including determinations of “aggressive driving”), whether anyone sub-rented the vehicle from secondary renter 152, whether secondary renter 152 filled the vehicle up with fuel, and/or any late surcharges attributable to secondary renter 152, primary renter 150, or another sub-renter, for example. Cost module 208 may charge an account (e.g., a credit card account) on file and associated with secondary renter 152. I/O module 202 may send a message to secondary renter 150 informing them of the charges.

After all sub-renters have concluded their rental durations and vehicle 116 is back at idle location 150C, access module 206 may unlock vehicle 116 for the primary renter 150. Alternatively, sub-rental server 101 may inform primary renter 150 of another available vehicle that primary renter 150 may use. An alternative vehicle may be used if one of the sub-renters was not able to return vehicle 116 back to idle location 150C, or use of an alternative vehicle may have been pre-arranged such that primary renter 150 was planning on using a different vehicle than vehicle 116. In either case, sub-rental server 101 may inform primary renter 150 of the location of vehicle 116 or an alternative vehicle. Upon physically locating vehicle 116 or an alternative vehicle, access module 206 or TCU module 117 may unlock the vehicle for the primary renter 150. Exemplary methods for unlocking vehicle 116 and assuring that primary renter 150 is physically proximate to the vehicle are described above. Upon accessing and starting the vehicle, the driving data may be recorded by TCU module 117 and transmitted to sub-rental server 101.

At 570, the rental duration 150A of primary renter 150 may come to an end and primary renter 150 may arrive at and park the vehicle at the designated drop-off location, which may be the same or different than the original rental location. After parking at the drop-off location, primary renter 150 may leave the keys in the vehicle.

At 580, primary renter 150 may be charged for the rental by cost module 208. Cost module 208 may take into account miles driven, fuel consumed, length of rental duration 150A, length of idle timeframe 150B, vehicle class 150D, rental location, drop-off location, driving data associated with primary renter 150 (including determinations of “aggressive driving”), whether anyone sub-rented the vehicle, whether primary renter 150 filled the vehicle up with fuel, and/or any late surcharges or fuel surcharges attributable to primary renter 150 or a sub-renter, for example. Cost module 208 may charge an account (e.g., a credit card account) on file and associated with primary renter 150. I/O module 202 may send a message to primary renter 150 informing them of the charges.

In addition to conventional road vehicles, the system and method may be extended to renting and sub-renting airplanes, boats, jet-skis, or other water vehicles, or all-terrain vehicles (ATVs, i.e., an off-road vehicle that is not conventionally driven on the road), for example. The disclosed embodiments are particularly advantageous when a vehicle (e.g., a jet ski or ATV) is rented at a rental office, then taken a long distance from the rental office along with another vehicle (e.g., a houseboat or truck). In the jet ski/houseboat example, the primary renter likely will not use the jet ski all the time, and may not want to return the jet ski to the rental office after using the jet ski for a relatively short period of time (relative to the overall duration of the boat vacation, for example). Rather, the primary renter may wish to stay at a distance (such as one side of Lake Powell, for example) and sub-rent the jet ski to another (secondary) renter to avoid being charged from the time of leaving the rental office to a time of returning the jet ski to the rental office. The primary renter can specify times when the jet ski will not be used, thereby enabling sub-rental of the otherwise underutilized jet ski. A similar scenario may be applicable in renting and sub-renting ATVs.

In summary, embodiments may provide a system and method for renting and sub-renting vehicles to one or more primary renters and secondary renters. In this manner, rented vehicles will be utilized more, particularly during periods when the primary renter has no need to use the rented vehicle. Secondary renters are enabled to use/rent the vehicle during these idle periods and the primary renter can avoid paying for more than he or she needs.

In the preceding specification, various embodiments have been described with reference to the accompanying drawings. It will, however, be readily evident that various modifications and changes may be made thereto, and additional embodiments may be implemented, without departing from the broader scope of the disclosure as set forth in the claims that follow. The specification and drawings are accordingly to be regarded in an illustrative rather than restrictive sense.

What is claimed is:

1. A method for sub-renting a vehicle, the method comprising:
receiving, at an I/O module, primary rental parameters from a primary renter, the primary rental parameters comprising:
a primary rental duration, and
an idle timeframe indicative of a period when the primary renter will not use the vehicle during the primary rental duration;
receiving, at the I/O module, secondary-rental parameters from a secondary renter, the secondary-rental parameters comprising:
a secondary rental duration, and
a secondary rental location;
comparing the primary rental parameters to the secondary rental parameters; and
authorizing the secondary renter to sub-rent the vehicle during the secondary rental duration and during at least a portion of the primary rental duration.

2. The method of claim 1, further comprising receiving, at the I/O module, an idle location at which the vehicle will be located at a beginning of the idle timeframe.

3. The method of claim 1, wherein the vehicle comprises a telematics control unit (TCU) comprising a location sensor, an accelerometer, and a gyroscope, wherein the TCU is configured to:
record driving data including mileage traveled, such that an amount of miles traveled by the primary renter and the secondary renter can be determined;
record locational data;
output an idle location of the vehicle at which the vehicle will be located at a beginning of the idle timeframe.

4. The method of claim 1, further comprising charging the primary renter and/or the secondary renter by an amount of miles travelled and not charging by a time duration.

5. The method of claim 1, further comprising unlocking the vehicle for the secondary renter, thereby allowing the secondary renter to retrieve keys to the vehicle from inside the vehicle.

6. The method of claim 1, wherein the comparing comprises determining whether the secondary rental duration is shorter in duration than the idle timeframe.

7. The method of claim 1, further comprising informing the primary renter, via the I/O module, of a location of the vehicle upon expiration of the idle timeframe or the secondary rental duration.

8. The method of claim 7, further comprising authorizing the primary renter to rent another vehicle upon a determination that the secondary rental duration extends beyond the idle timeframe.

9. The method of claim 1, wherein the vehicle is a water vehicle or an all-terrain vehicle (ATV).

10. The method of claim 1, further comprising authorizing another secondary renter to rent the vehicle after expiration of the secondary rental duration.

11. A system for sub-renting a vehicle, the system comprising:
an I/O module configured to receive:
primary rental parameters from a primary renter, the primary rental parameters comprising:
a primary rental duration, and
an idle timeframe indicative of a period when the primary renter will not use the vehicle during the primary rental duration;
secondary-rental parameters from a secondary renter, the secondary-rental parameters comprising:
a secondary rental duration, and
a secondary rental location;
a renting module configured to:
compare the primary rental parameters to the secondary rental parameters, and
authorize the secondary renter to sub-rent the vehicle during the secondary rental duration and during at least a portion of the primary rental duration.

12. The system of claim 11, wherein the I/O module is further configured to receive an idle location at which the vehicle will be located at a beginning of the idle timeframe.

13. The system of claim 11, wherein the vehicle comprises a telematics control unit (TCU) comprising a location sensor, an accelerometer, and a gyroscope, wherein the TCU is configured to:
record driving data including mileage traveled, such that an amount of miles traveled by the primary renter and the secondary renter can be determined;
record locational data;
output an idle location of the vehicle at which the vehicle will be located at a beginning of the idle timeframe.

14. The system of claim 11, further comprising a cost module configured to charge the primary renter and/or the secondary renter by an amount of miles travelled and not charge by a rental duration.

15. The system of claim 11, wherein the TCU is further configured to unlock the vehicle for the secondary renter, thereby allowing the secondary renter to retrieve keys to the vehicle from inside the vehicle.

16. The system of claim 11, wherein the renting module is further configured to determine whether the secondary rental duration is shorter in duration than the idle timeframe.

17. The system of claim 11, wherein the I/O module is further configured to inform the primary renter of a location of the vehicle upon expiration of the idle timeframe or the secondary rental duration.

18. The system of claim 17, wherein the renting module is further configured to authorize the primary renter to rent another vehicle upon a determination that the secondary rental duration extends beyond the idle timeframe.

19. The system of claim 11, wherein the vehicle is a water vehicle or an all-terrain vehicle (ATV).

20. The system of claim 11, wherein the renting module is further configured to authorize another secondary renter to rent the vehicle after expiration of the secondary rental duration.
